(19) United States
(12) Patent Application Publication
(10) Pub. No.: US 2002/0059385 A1
(43) Pub. Date: May 16, 2002

(54) Method of anti-spam

(76) Inventor: Hai Lin, Shanghai (CN)

Correspondence Address: OSTROLENK FABER GERB & SOFFEN, 1180 AVENUE OF THE AMERICAS, NEW YORK, NY, 100368403

(21) Appl. No.: 09/915,927

(22) Filed: Jul. 26, 2001

(30) Foreign Application Priority Data
Jul. 29, 2000 (CN) 089115204

(51) Int. Cl. G06F 15/16

(52) U.S. Cl. 709/206

(57) ABSTRACT

A method of anti-spam is to set an optional trustcode, or a trustlist, or at least a trustweb based on online mail delivery at a recipient's e-mail address. A mail sender is compelled at the first time to deliver a mail by way of: taking the way of “Visiting trustweb and sending online”, or enclosing the recipient's trustcode in the mail and sending in another way other than the mentioned. After the sender's e-mail address has been stored automatically in the recipient's trustlist, the sender may send mails to the same recipient in whatever the ways feasible.

### BACKGROUND OF THE INVENTION

This invention relates to e-mail technology, particularly to a method of anti-spam.

It is indisputable that the electronic mail (e-mail) is a popular and efficient way of data communication in today's living, however, people have to face the inundated unwanted mails on the other hand while they are in the enjoyment of convenience.

The methods available so far for tackling with junk e-mail seem to be concentrated in the filter technology, namely, the recipient side is supposed to establish an address list of e-mail senders or specified character strings welcome as snow in harvest for filtering purposes. The following listed patents are suggested for reference:

U.S. Pat. No. 6,023,723;

Canada patent No. 2282502;

PCT patent No. WO 98/00787; WO 98/37680; WO 99/32985; WO 99/37066; WO 99/67731.

### SUMMARY OF THE INVENTION

The filter technology can indeed block part of the junk mails and is widely implemented, whereas it is found defective in the following aspects:

(1) The recipient side usually cannot perceive before hand a sender's mail address, or a sender may change his/her mail address from time to time, or he/she will leave no mail address behind.

(2) To judge whether an electronic mail is a junk mail or not by searching some specified character strings can work with limited effect.

(3) The filter technology requires frequent updating.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a flowchart of proposal (1); and

FIG. 2 is a flowchart of proposal (2).

### DETAILED DESCRIPTION OF THE INVENTION

The primary object of this invention is to provide a method of anti-spam, characterized in:

1) Setting a trustcode at a recipient's e-mail address, which, the trustcode, is an optional character string to be or not to be utilized depending upon a recipient's will and can be changed at any minute, for example, a trustcode of tc2000 for the e-mail address-usemame@mailserver.com. There are two ways for setting the trustcode, namely: setting it in an e-mail server and web server or on an e-mail client system.

2) Setting a trustlist at a recipient's e-mail address, which, the trustlist, has stored a plurality of e-mail sender's addresses. Similarly, there are two ways for setting the trustlist, namely: setting it in the e-mail server and web server or in the e-mail client system.

3) Setting at least a web-based mail-sending web site trustweb at a recipient's e-mail address. There are two ways for setting the trustweb: setting it under a domain name that a target e-mail address belongs to as a domain-name based private trustweb or under another domain as a public trustweb to serve for a mail-sending site.

4) Compelling an e-mail sender to choose one of the ways below for sending a mail in case the mail address of the sender is not yet registered in the recipient's trustlist:

(1) Visiting a recipient's trustweb and online sending a mail to the recipient on web basis. For instance, a recipient's e-mail address is ursername@mailserver.com and the trustweb is www.mailserver.com, then the sender has to link the web, visit that web site, and online send a mail to the recipient; and

(2) Sending a mail in some other way including using available e-mail software at a user's end in accordance with the Simple Mail Transfer Protocol (SMTP), wherein the mail to be sent should contain the recipient's trustcode. In the case the recipient hasn't yet set his or her trustcode, the mail sender is compelled to implement the way (1).

5) Storing a sender's e-mail address automatically in a recipient's trustlist after a mail is successfully sent to reach the recipient's e-mail server and web server or downloaded by the recipient according to any of abovesaid mail-sending ways.

6) After a sender's e-mail address being stored in a recipient's trustlist, the sender being permitted to send a mail in any possible way without being restricted in online sending at a recipient's trustweb or carrying a recipient's trustcode.

7) Carrying a recipient's trustcode by way of:

7-1) Encoding a trustcode into a target e-mail address. A method is to take a trustcode as the end code of a username in an e-mail address and insert a symbol “−” for splitting between the usemame and the trustcode so as to serve for a new username to be added with a domain name to form a new e-mail address. For example, an e-mail address “username@mailserver.com” is added with a trsucode of “tc2000” to become a newly encoded e-mail address “username-tc2000 mailserver.co”. When an electronic mail is sent to reach a recipient side server, then the server will decode to obtain the target mailbox as “username@mailserver.com” with a trsutcode of tc2000.

7-2) Encoding a trustcode into the subject of an electronic mail to be sent out. A method is to include a trustcode between the symbol “<” and “>”, then is combined to the mail subject. For example:

before encoding, subject: hello

after encoding, subject: hello <tc2000>where tc2000 is the trustcode of a target e-mail address.

7-3) Encoding a trustcode into the text of a mail to be sent out. A method is to place trustcode in the first row of the mail text.

7-4) enclosing a trustcode in a mail format as an extra item. The main format of mail usually comprises:

FROM: a sender's e-mail address

REPLY TO: an e-mail address for reply

TO: a recipient's e-mail address

SUBJECT: a mail subject

BODY: a mail text

TRUSTCODE: a recipient's trsutcode -an extra item

8) Returning the mail to its sender with default content reminding the sender of the way of “visiting trustweb and sending online”. In the case either a recipient hasn't yet set a trustcode or the sender's e-mail address not yet stored in the recipient's trustlist, the mail will be returned to its sender should it be sent in a way other than the method of “visiting trustweb and sending online.”

9) Returning the mail to its sender with default content reminding the sender of the recipient's correct trustcode or the way of “visiting trustweb and sending online”. In the case a recipient has already set a trsutcode while the sender's e-mail hasn't yet duly stored in the recipient's trustlist and when a mail is sent in a way other than the method of “visiting trustweb and sending online.”

According to the method mentioned, a junk mail cannot be massively released as done traditionally for the reason the recipients' trustcode are unknown to the sender, nevertheless, the way of “visiting trustweb and sending online” is somewhat unfit for automatic massive operation, so that unwanted junk mails can be efficiently rejected. Moreover, the recipient is permitted to change the trustcode of his/her e-mail address any time for prevention of junk mails without changing the e-mail address in case the trustcode is disclosed.

When this invention is applied at a recipient's side, a mail sender must be troubled to take the procedure of “visiting trustweb and sending online” at the first time so that he/she can send a mail to the recipient without being rejected. Afterwards, as the sender's e-mail address is registered in the recipient's trustlist, the sender can send a mail to the same recipient as usual without troubling again to play the game of “visiting trustweb and sending online”. Of course, a recipient may have stored some e-mail addresses of trustable mail senders in his trustlist before hand to facilitate mail communication.

The primary object of arrangement of a recipient's trustlist is that the recipient may inform some trustable mail senders of his/her trustcode so that the trustable senders may send mails to this recipient as usual by using the prevailed software at the client end without troubling to play the mentioned “visiting trustweb and sending online.” Besides, as described in 7-1), the trustcode may be concealed in an e-mail address and is compatible to the existing format of e-mail address that warrants normal e-mail services at the recipient's side, such as the mailing list service, etc. The mailing list service is usually adopted for sending massive mails automatically, hence, setting a trustcode at the recipient's side is considered necessary. For example, in case a recipient has registered his/her e-mail address for mailing list service as username@mailserver.com, then the mails sent according to the mailing list will be deemed a junk mail and rejected. Instead, if a trustcode of tc2000 is added to become username-tc2000 @mailserver.com, then it works to enjoy the mailing list service.

When compared with the conventional filter technology, this invention is more powerful and efficient in prevention of junk mails and more advantageous in: no need of identifying the junk mail sender, no need of inferring whether a coming mail is a junk mail or not, and no need of updating the filter techniques at a recipient's side endlessly.

There are two proposals for embodiment of this invention, in which proposal 1 is based on the e-mail server and web server or the other, proposal 2, the e-mail client system.

In the proposal 1, a single domain name is applied in both the e-mail server and the web server.

The e-mail server should be endowed with functions including:

A) Analyzing and judging whether a coming mail encloses the recipient's trustcode or not;

B) Judging whether the e-mail address of a mail sender is included in the recipient's trustlist or not;

C) Automatic mail-return function;

D) Automatic trustlist updating function.

Further, an extra function for discriminating whether a coming mail belongs to a public trustweb or not by examining its IP (Internet Protocol) address or digital signature is optional.

The web server should be endowed with functions including:

A) Serving as a private trustweb that enables a mail sender to online send out a mail to all the e-mail addresses in the scope of a single domain name;

B) Enabling an e-mail client (recipient) to set/alter his/her trustcode;

C) Enabling an e-mail client (recipient) to edit/manage his/her trustlist; and

D) Enabling an e-mail client (recipient) to edit a standard text for mail return.

Further, an extra function for building a plurality of public trustwebs to enable a mail sender to online send out a mail with digital signature of a web site is optional.

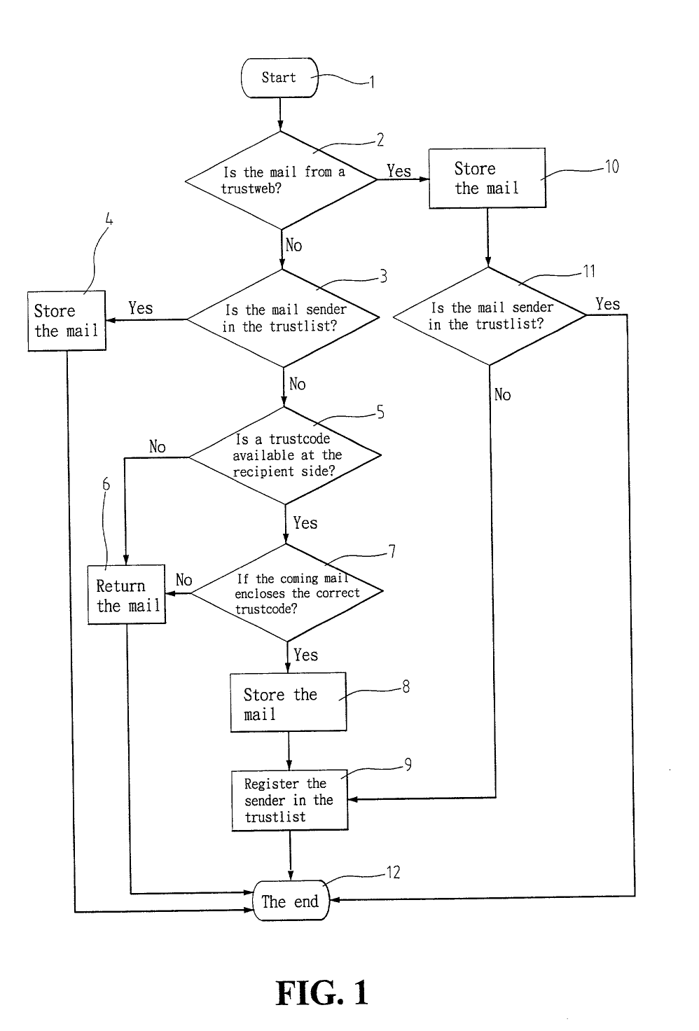

According to a flowchart of the proposal 1 shown in FIG. 1, in the case a sender is to send a mail from a private trustweb of a target e-mail address, the procedure may go directly to “store mail” by waiving “judge the mail source” aside.

If a mail come from a public trustweb, it should undergo a discrimination of IP address or digital signature for source judgment.

The proposal 2, based on the e-mail client system, should be endowed with functions including:

A) Enabling an e-mail client (recipient) to set/alter his/her trustcode;

B) Enabling an e-mail client (recipient) to edit/manage his/her trustlist;

C) Enabling an e-mail client (recipient) to edit a standard text for mail return;

D) Discriminating whether a coming mail is sent from a public trustweb or not;

E) Analyzing and judging whether a coming mail encloses the recipient's trustcode or not;

F) Judging whether a sender's e-mail address is included in the recipient's trustlist or not;

G) A function for automatic mail return; and

H) A function for updating the trustlist.

Further, an extra function for building a plurality of public trustwebs to enable a mail sender to online send out a mail with digital signature of a web site is optional.

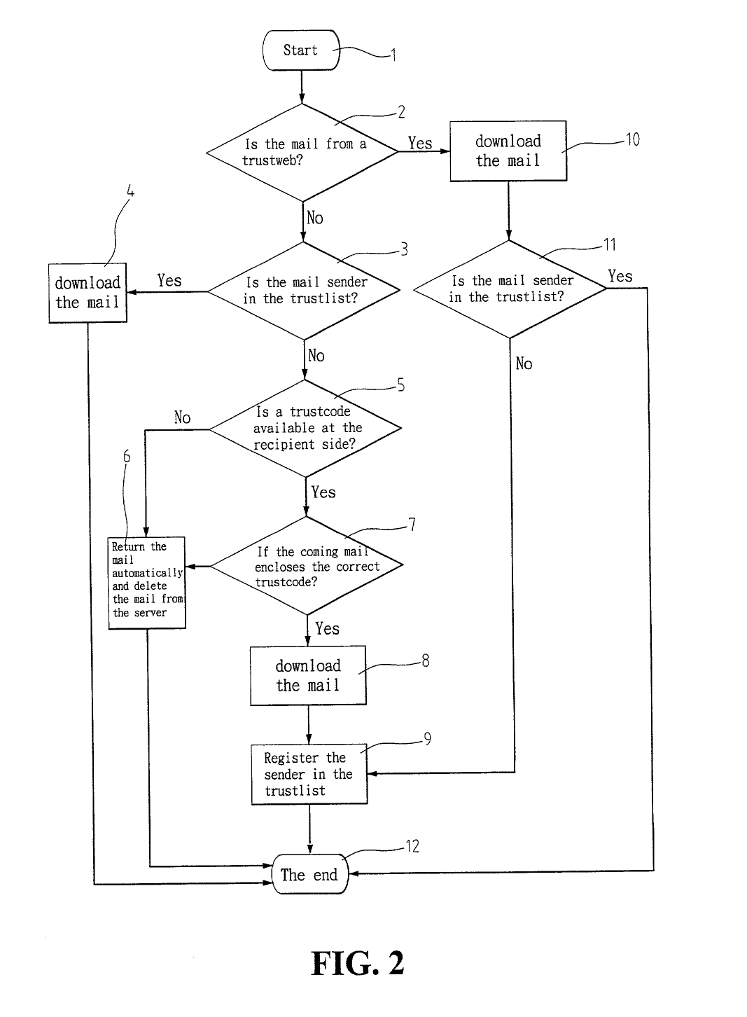

FIG. 2 shows a flowchart of the proposal 2, in which judging whether a coming mail is sent from a public trustweb or not can be made by examining its IP address or digital signature.

The function for automatic mail return is considered the first priority in this proposal. If the text of a coming mail is relatively shorter, the original text may be enclosed in a mail return message or only a small part of it is enclosed in a longer one or even entirely waived for time saving in mail return operation. The original mail will be deleted from the server after mail return is made.

This proposal is considered defective for it fails to conceal the trustcode in a target e-mail address, which is done as described in 7-1). For example, when a trustcode of tc2000 is added to an e-mail address “username@mailserver.com” to become “username-tc2000@mailserver.com” which would be considered another independent address or an illegal address by the server, so that the client cannot enjoy some normal e-mail services, particularly the mailing list service. As a matter of fact, this defect can be solved easily by adding a trustcode to a web page for client registration by the mailing list service company after this invention is widely used. The major merit of this invention is that massive clients can use it immediately without waiting for performance of the proposal 1 by the e-mail service company.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method of anti-spam, comprising:
setting a trustcode at a recipient's e-mail address, which, the trustcode, is an optional character string to be or not to be utilized depending upon a recipient's will and can be changed whenever desired;
setting a trustlist at a recipient's e-mail address, which, the trustlist, has stored a plurality of e-mail sender's addresses; and
setting at least a web-based online mail-sending web site “trustweb” at a recipient's e-mail address; wherein
a mail sender is compelled to choose one of the following two ways for sending out a mail to reach a recipient should his/her e-mail address hasn't yet been registered in the recipient's trustlist:
(1) Visiting the recipient's trustweb and online sending a mail to the recipient on web basis; or
(2) Sending a mail in some other way which should include the recipient's trustcode in his/her mail, or taking (1) if no recipient's trustcode available;
a sender's e-mail address will be registered in a recipient's trustlist automatically after a mail is successfully sent to reach the recipient's e-mail server or downloaded by the recipient by any of abovesaid mail-sending ways; and after a sender's e-mail address is stored in the recipient's trustlist, the sender is permitted to send a mail in any possible way without being restricted in online sending at the recipient's trustweb or carrying the recipient's trustcode.

2. The method of anti-spam according to claim 1, wherein a method for setting the trustcode at a recipient's e-mail address is to set the trustcode in the recipient's e-mail server and web server for checking if the recipient's trustcode is enclosed in a coming mail or not.

3. The method of anti-spam according to claim 1, wherein a method for setting the trustcode at a recipient's e-mail address is to set the trustcode in the recipient's e-mail client system for checking whether the recipient's trustcode is enclosed in a coming mail downloaded by the e-mail server and web system or not.

4. The method of anti-spam according to claim 1, wherein a method for setting a truslist at a recipient's e-mail address is to set the trustlist in a recipient's e-mail server and web server for storing a mail sender's e-mail address automatically in the recipient's trustlist after a mail is sent by any of said two ways to successfully reach the recipient's e-mail server and web server.

5. The method of anti-spam according to claim 1, wherein a method for setting a truslist at a recipient's e-mail address is to set the trustlist in a recipient's e-mail client system for storing a mail sender's e-mail address automatically in the recipient's trustlist after a mail is sent by any of said two ways to successfully reach the recipient's e-mail server and web server and downloaded.

6. The method of anti-spam according to claim 1, wherein a method for setting a trustweb at a recipient's e-mail address is to set a private trustweb at the recipient's e-mail address under a single domain name.

7. The method of anti-spam according to claim 1, wherein a method for setting a trustweb at a recipient's e-mail address is to set a plurality of optional public trustwebs under different domain names.

8. The method of anti-spam according to claim 1, wherein an electronic mail will be returned with default content reminding the mail sender of the way of “visiting trustweb and sending online” under coexistence of the following conditions: a) No trustcode available at the recipient's side; b) Not yet a registration of a sender's e-mail address made in the recipient's trustlist; and c) a mailing way other than the “visiting trustweb and sending online” being adopted by a sender; and
an electronic mail will be returned with default content reminding the mail sender of the recipient's correct trustcode or the way of “visiting trustweb and sending online” under coexistence of the following conditions: a) A trustcode available at the recipient side; b) Not yet a registration of a sender's e-mail address made in the recipient's trustlist; and c) A mail sent without enclosing the recipient's trustcode by a way other than the “visiting trustweb and sending online.”

9. The method of anti-spam according to claim 1, wherein a method for sending an electronic mail by enclosing a recipient's trustcode includes:
encoding a character string in the target e-mail address; or
encoding the character string in a mail subject; or
encoding the character string in the mail text; or
treating the trustcode as an extra item and arranging it in the e-mail format.

10. The method of anti-spam according to claim 9, wherein the method for sending an electronic mail by enclosing a recipient's trustcode is characterized in:
taking the trustcode as the end code of a username in an e-mail address and inserting a symbol “−” for splitting between the username and the trustcode so as to serve for a new username to be added with a domain name to form a new e-mail address.
